(19) United States
(12) Patent Application Publication
(10) Pub. No.: US 2010/0045813 A1
(43) Pub. Date: Feb. 25, 2010

(54) DIGITAL IMAGE CAPTURE DEVICE AND VIDEO CAPTURING METHOD THEREOF

(75) Inventor: Zheng-Yong Chen, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/392,920

(22) Filed: Feb. 25, 2009

(30) Foreign Application Priority Data
Aug. 21, 2008 (CN) 200810304132.8

(51) Int. Cl. H04N 5/228; H04N 5/232; G06F 3/041

(52) U.S. Cl. 348/222.1; 348/345; 348/347; 345/173; 348/E05.031; 348/E05.043

(57) ABSTRACT

A method for capturing video comprising: capturing video of a moving object, the video comprising a current image and a subsequent image; selecting a portion of each image of the captured video which contains the moving object; copying the selected portions as new images; and encoding the new images into new video.

### BACKGROUND

1. Technical Field

The disclosure relates to digital image capture devices and, particularly, to a digital image capture device capable of capturing blur-less video and a video capturing method thereof.

2. Description of the Related Art

When capturing video, a user's aim and hand holding the video camera or other image capture device having video capturing function must be continuously adjusted to track a moving object of interest. However, the adjustments may cause camera shake, resulting in blurry/smeared video.

Therefore, it is desirable to provide a digital image capture device and a video capturing method thereof, which can overcome the limitations described above.

### BRIEF DESCRIPTION OF THE DRAWINGS

FIG. 1 is a block diagram of a digital image capturing device which includes a display, according to an exemplary embodiment.

FIG. 2 is a schematic view of the display of FIG. 1.

FIG. 3 is a flowchart of a video capturing method, according to another exemplary embodiment.

### DETAILED DESCRIPTION OF THE EMBODIMENTS

Embodiments of the digital image capture device and video capturing method thereof are described in detail here with reference to the drawings.

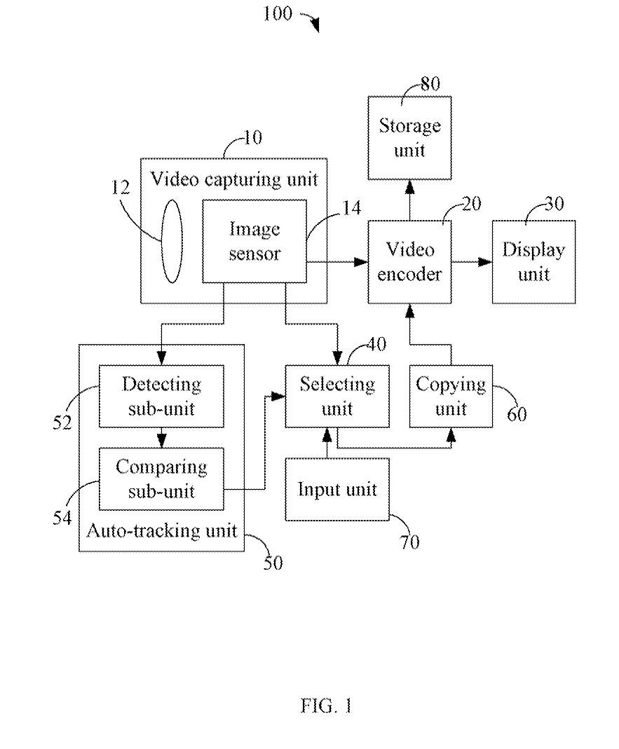

As shown in FIG. 1, a digital image capture device 100, according to an exemplary embodiment, includes a video capturing unit 10, a video encoder 20, a display unit 30, a selecting unit 40, an auto-tracking unit 50, a copying unit 60, an input unit 70, and a storage unit 80.

The video capturing unit 10 is configured for capturing video. In particular, the video capturing unit 10 includes a lens 12 and an image sensor 14. The lens 12 is configured for directing light from objects onto the image sensor 14. The image sensor 14 such as a charge-coupled device (CCD) is configured for converting the light incident thereon into video that contains consecutive images at a predetermined rate, e.g., 120 images per second. The lens 12 is beneficially a wide-angle lens. As a result, the video capturing unit 10 can capture video of a moving object of interest without adjustments thereof or with reduced adjustments thereof, as compared with a normal lens or a telephoto lens. In this case, the moving object of interest may appear tiny in the captured video. However, this issue can be solved by the digital image capture device 100. In other alternative embodiments, the lens 12 can be a zoom lens and is used at its wide-angle state.

The video encoder 20 is configured for encoding the images into video.

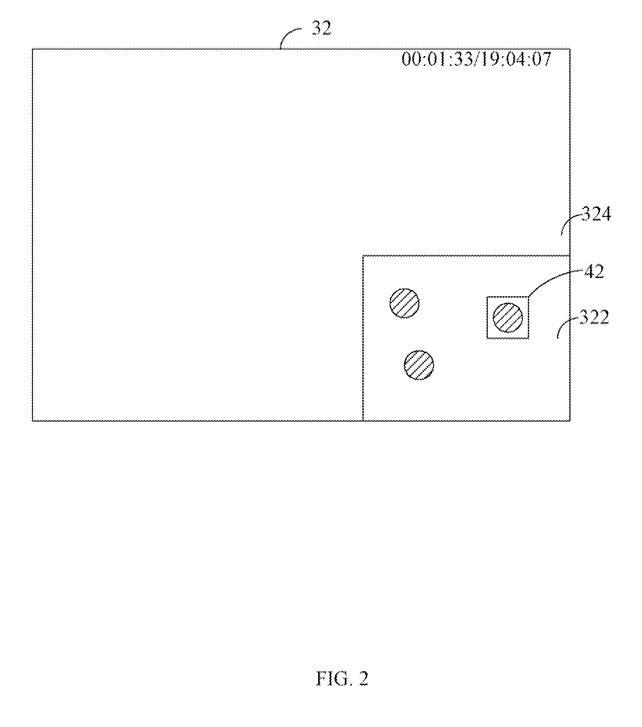

Also referring to FIG. 2, the screen 32 of the display unit 30 is subdivided into two regions: a whole-field region 322 and a portion-enlarged region 324. The whole-field region 322 is configured for displaying the captured video. Thereby, a user can determine whether the view of the lens 12 is desired according to the screen view. If not, adjustment is needed. In this embodiment, the display unit 30 is also configured for displaying elapsed capture time and available time for capture at, e.g., the top left corner thereof.

The selecting unit 40 is configured for selecting a portion of each image of the captured video that includes the moving object of interest. Also, the selecting unit 40 can be further configured for generating a highlight frame 42, which is displayed on the displayed captured video and configured for indicating which portion of a current image of the captured video is selected. Thereby, a user can determine whether the selection is correct or desirable, according to the screen view. Occasionally, the video may include more than one moving object. In these cases, the selecting unit 40 can select any one of the moving objects according to the screen view and user input.

The auto-tracking unit 50 is configured for tracking the moving object of interest and thereby helping the selecting unit 40 to track the moving object of interest in the captured video. In particular, the auto-tracking unit 50 includes a detecting sub-unit 52 and a comparing sub-unit 54. The detecting sub-unit 52 is configured for detecting the moving object of interest in a current image and a subsequent image, using available pattern recognition algorithms. The comparing sub-unit 54 is configured for comparing the relative positions of the moving object of interest in the two images and thereby determined how to change the selection. For example, if the comparing sub-unit 54 shows that the moving object of interest moves to left 0.05 millometer (mm) in the subsequent image, as compared with the current image. The comparing sub-unit 54 will tell the selecting unit 40 to move its selection of the portion of the subsequent image to left 0.05 mm accordingly, as compared with the current image. Also, the selecting unit 40 will update the displayed highlight frame accordingly. Thereby, the user can judge whether the auto-tracking unit 50 works well, according to the screen view.

In other alternative embodiments, the tracking of the moving object of interest also can be done according to user input via the input unit 70. For example, in an embodiment, the display unit 30 and the input unit 70 are integrated into a touch screen allowing hand-writing. Thereby, the tracking of the moving object of interest can be accomplished by continuously drawing the highlight frame to always include the moving object of interest therein using the hand-writing function of the touch screen.

The copying unit 60 is configured for copying the selected portions as new consecutive images and sending the copied new images to the video encoder 20. Then the new images are encoded as new video of the moving object of interest. In the new video, the moving object of interest is enlarged, as compared with the image size of the new video, and accordingly becomes the main subject of the video.

The new video can be sent to the display unit 30 and is displayed on the portion-enlarged region 324. Thereby, the user can decide whether the new video is what they want. In order to clearly view the new video, the portion-enlarged region may be greater than the whole-field region in size. If the new video is acceptable, it will be stored in the storage unit 80. The storage unit 80 also can be used to store the captured video.

Various components of the digital image capture device 100 such as the video encoder 20, the selecting unit 40, the auto-tracking unit 50, and the copying unit 60 can be individual chips or integrated into a single chip, e.g., a micro control unit (MCU). Also, these components can be software modules written in variety of software language such as C, C++, visual C++ or visual B and, when executed by hardware, can provide corresponding functionablities.

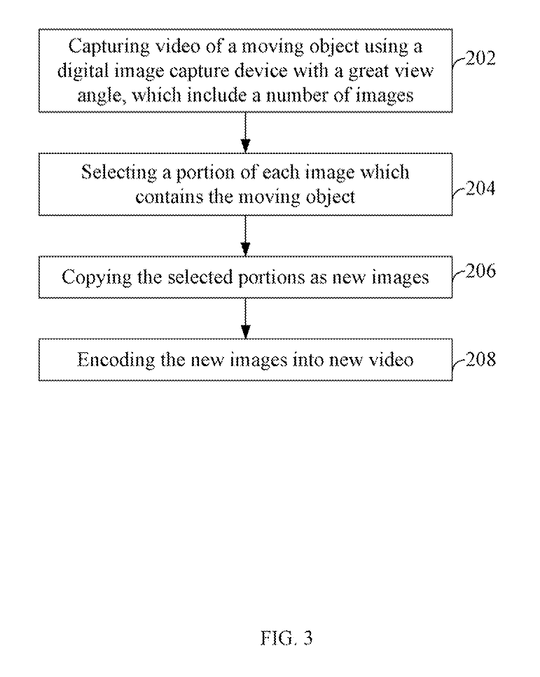

Referring to FIG. 3, a video capturing method, according to another exemplary embodiment, can be carried out by the digital image capture device 100 and includes the following steps.

Step 202: capturing video of a moving object of interest. The video includes a current image and a subsequent image. This step can be carried out by the video capturing unit 10. As disclosed above, the video capturing unit 10 beneficially has a wide field angle. Thereby, the video capturing unit 10 can capture the video of the moving object of interest with fewest adjustments of the digital image capture device 100.

Step 204: selecting a portion of each image that includes the moving object of interest. This step can be carried out by the selecting unit 40 and the auto-tracking unit 50. In particular, the captured video is encoded by the video encoder 20 and is displayed on the whole-field region 322 of the display unit 30. This step may also generate the highlight frame 42, which is displayed on the displayed captured video to indicate which portion of the images is selected. Thereby the user can judge whether the selection is the correct or desired one. The selection of the portion is developed by the auto-tracking unit 50 or according to the user input via the input unit 70 (see above).

Step 206: copying the selected portions as new images. This step can be carried out by the copying unit 60.

Step 208: encoding the new images as new video. This step can be carried out by the video encoder 20. The new video can be displayed on the portion-enlarged region 324 of the display unit 30.

While the disclosure has been described by way of example and in terms of preferred embodiment, it is to be understood that the disclosure is not limited thereto. To the contrary, it is intended to cover various modifications and similar arrangements, which would be apparent to those skilled in the art. Therefore, the scope of the appended claims should be accorded the broadest interpretation so as to encompass all such modifications and similar arrangements.

What is claimed is:

1. A digital image capture device comprising:
a video capturing unit configured for capturing video of a moving object, the captured video comprising a current image and a subsequent image;
a selecting unit configured for selecting a portion of each image which contains the moving object;
a copying unit configured for copying the selected portions as new images; and
an encoding unit configured for encoding the copied images into new video of the moving object.

2. The digital image capture device as claimed in claim 1, wherein the video capturing unit comprises a lens and an image sensor, the lens is configured for directing object light onto the image sensor, and the image sensor is configured for converted the object light into video.

3. The digital image capture device as claimed in claim 2, wherein the lens comprises a wide-angle lens.

4. The digital image capture device as claimed in claim 2, wherein the lens comprises a zoom lens.

5. The digital image capture device as claimed in claim 2, wherein the image sensor comprises a charge-coupled device.

6. The digital image capture device as claimed in claim 1, further comprising a display unit, the display unit being configured for displaying the captured video and the new video.

7. The digital image capture device as claimed in claimed 1, further comprising a display unit, the screen of display unit being divided into a whole-field region and a portion-enlarged region, the whole-field region being configured for displaying the captured video, and the portion-enlarge region being configured for displaying the new video.

8. The digital image capture device as claimed in claim 7, wherein the portion-enlarged region is greater than the portion-enlarged region in size.

9. The digital image capture device as claimed in claim 1, further comprising a display unit, the display panel being configured for displaying the captured video, the selecting unit being configured for generating a highlight frame, the highlight frame being displayed on the displayed captured video and configured for indicating which portion of the images is selected.

10. The digital image capture device as claimed in claim 1, wherein the captured video comprises a plurality of moving objects, the selecting unit being capable of selecting any one of the moving objects in response to user input.

11. The digital image capture device as claimed in claim 1, further comprising an auto-tracking unit, the auto-tracking unit being configured for tracking the moving object and thereby helping the selecting unit to track the moving object in the captured video.

12. The digital image capture device as claimed in claim 11, wherein the auto-tracking unit comprises a detecting sub-unit and a comparing sub-unit, the detecting sub-unit is configured for detecting the moving object using pattern recognition algorithms, the comparing sub-unit is configured for comparing the relative positions of the moving object of interest in the current image and the subsequent image and thereby determining how the selecting unit moves the selection in the subsequent image.

13. The digital image capture device as claimed in claim 1, further comprising an input unit, the selecting unit tracking the moving object in the captured video in response to user input via the input unit.

14. The digital image capture device as claimed in claim 1, further comprising a display unit and an input unit, the display unit being configured for displaying the captured video, the selecting unit being configured for generating a highlight frame which is displayed on the displayed captured image, the highlight frame being continuously drawn to a portion of the image containing the moving object therein in response to user input via the input unit.

15. The digital image capture device as claimed in claim 14, wherein the display unit and the input unit are integrated into a touch screen.

16. The digital image capture device as claimed in claim 1, further comprising a storage unit, the storage unit being configured for storing the captured video and the new video.

17. A video capturing method comprising:
capturing video of a moving object, the video comprising a current image and a subsequent image;
selecting a portion of each image that contains the moving object;
copying the selected portions as new images; and
encoding the new images into new video.

18. The video capturing method as claimed in claim 17, wherein the video is captured using a lens of great view angle.

19. The video capturing method as claimed in claim 17, further comprising:
detecting the moving object in the captured video; and
comparing the relative positions of the moving object in the current image and the subsequent image to track the moving object in the subsequent image.

20. The video capturing method as claimed in claim 17, further comprising:
tracking the moving object in the captured video in response to user input.
